(19) United States
(12) Patent Application Publication
(10) Pub. No.: US 2009/0279503 A1
(43) Pub. Date: Nov. 12, 2009

(54) SYSTEMS AND METHODS FOR MULTIMODE WIRELESS COMMUNICATION HANDOFF

(75) Inventors: Tom Chin, San Diego, CA (US); Kuo-Chun Lee, San Diego, CA (US); Ayman Fawzy Naguib, Cupertino, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/176,304

(22) Filed: Jul. 18, 2008

Related U.S. Application Data
(60) Provisional application No. 61/052,265, filed on May 11, 2008.
(60) Provisional application No. 61/052,266, filed on May 11, 2008.

(51) Int. Cl. H04Q 7/00

(52) U.S. Cl. 370/331

(57) ABSTRACT

Methods and apparatus for base-station-assisted handover between WiMAX (Worldwide Interoperability for Microwave Access) and CDMA (Code Division Multiple Access) EVDO (Evolution-Data Optimized) or 1xRTT (one times Radio Transmission Technology, or 1x) networks during normal operation of a dual-mode mobile station (MS) are provided. By having a base station (BS) using one radio access technology (RAT) broadcast information about a BS in a neighboring cell employing a different RAT, the methods and apparatus may improve service continuity during handover.

### CLAIM OF PRIORITY

This application claims benefit of priority from U.S. Provisional Patent Application Ser. No. 61/052,265, filed May 11, 2008 and entitled “Systems and Methods for Multimode Wireless Communication Handoff,” and from U.S. Provisional Patent Application Ser. No. 61/052,266, also filed May 11, 2008 and also entitled “Systems and Methods for Multimode Wireless Communication Handoff,” both of which are fully incorporated by reference herein for all purposes.

### CROSS-REFERENCE TO RELATED APPLICATIONS

This application is related to U.S. patent application Ser. No. ______ (Attorney Docket No. 080489), filed the same day as this application and entitled “Systems and Methods for Multimode Wireless Communication Handoff,” with inventors Tom Chin and Kuo-Chun Lee, which is assigned to the assignee of this application.

### TECHNICAL FIELD

Certain embodiments of the present disclosure generally relate to wireless communications and, more particularly, to a base-station-assisted handover of a mobile station from a WiMAX network to a CDMA network, and vice versa.

### BACKGROUND

Orthogonal frequency-division multiplexing (OFDM) and orthogonal frequency division multiple access (OFDMA) wireless communication systems under IEEE 802.16 use a network of base stations to communicate with wireless devices (i.e., mobile stations) registered for services in the systems based on the orthogonality of frequencies of multiple subcarriers and can be implemented to achieve a number of technical advantages for wideband wireless communications, such as resistance to multipath fading and interference. Each base station (BS) emits and receives radio frequency (RF) signals that convey data to and from the mobile stations. For various reasons, such as a mobile station (MS) moving away from the area covered by one base station and entering the area covered by another, a handover (also known as a handoff) may be performed to transfer communication services (e.g., an ongoing call or data session) from one base station to another.

Three handover methods are supported in IEEE 802.16e-2005: Hard Handoff (HHO), Fast Base Station Switching (FBSS) and Macro Diversity Handover (MDHO). Of these, supporting HHO is mandatory in the standard, while FBSS and MDHO are two optional alternatives.

HHO implies an abrupt transfer of connection from one BS to another. The handover decisions may be made by the MS or the BS based on measurement results reported by the MS. The MS may periodically conduct an RF scan and measure the signal quality of neighboring base stations. The handover decision may arise, for example, from the signal strength from one cell exceeding the current cell, the MS changing location leading to signal fading or interference, or the MS requiring a higher Quality of Service (QoS). Scanning is performed during scanning intervals allocated by the BS. During these intervals, the MS is also allowed to optionally perform initial ranging and to associate with one or more neighboring base stations. Once a handover decision is made, the MS may begin synchronization with the downlink transmission of the target BS, may perform ranging if it was not done while scanning, and may then terminate the connection with the previous BS. Any undelivered Protocol Data Units (PDUs) at the BS may be retained until a timer expires.

When FBSS is supported, the MS and BS maintain a list of BSs that are involved in FBSS with the MS. This set is called a diversity set. In FBSS, the MS continuously monitors the base stations in the diversity set. Among the BSs in the diversity set, an anchor BS is defined. When operating in FBSS, the MS only communicates with the anchor BS for uplink and downlink messages including management and traffic connections. Transition from one anchor BS to another (i.e., BS switching) can be performed if another BS in the diversity set has better signal strength than the current anchor BS. Anchor update procedures are enabled by communicating with the serving BS via the Channel Quality Indicator Channel (CQICH) or the explicit handover (HO) signaling messages.

A FBSS handover begins with a decision by an MS to receive or transmit data from the Anchor BS that may change within the diversity set. The MS scans the neighbor BSs and selects those that are suitable to be included in the diversity set. The MS reports the selected BSs, and the BS and the MS update the diversity set. The MS may continuously monitor the signal strength of the BSs that are in the diversity set and selects one BS from the set to be the anchor BS. The MS reports the selected anchor BS on CQICH or MS-initiated HO request message.

For MSs and BSs that support MDHO, the MS and BS maintain a diversity set of BSs that are involved in MDHO with the MS. Among the BSs in the diversity set, an anchor BS is defined. The regular mode of operation refers to a particular case of MDHO with the diversity set consisting of a single BS. When operating in MDHO, the MS communicates with all BSs in the diversity set of uplink and downlink unicast messages and traffic.

An MDHO begins when an MS decides to transmit or receive unicast messages and traffic from multiple BSs in the same time interval. For downlink MDHO, two or more BSs provide synchronized transmission of MS downlink data such that diversity combining is performed at the MS. For uplink MDHO, the transmission from an MS is received by multiple BSs where selection diversity of the information received is performed.

### SUMMARY

Certain embodiments of the present disclosure generally relate to performing base-station-assisted handover of a mobile station (MS) from one radio access technology (RAT) network to another different RAT network, such as from a WiMAX network to a CDMA network, and vice versa, during normal operation of an MS, thereby allowing better service continuity while the MS moves from one network to the next.

Certain embodiments of the present disclosure provide a method for performing handover between network service via first and second RATs, wherein the first and second RATs are different. The method generally includes receiving neighbor indication information about network service via the second RAT while communicating via the first RAT, scanning for the second RAT using the received information, and determining whether to handover to network service via the second RAT based on results of the scanning.

Certain embodiments of the present disclosure provide a computer-readable medium containing a program for performing handover between network service via first and second radio RATs, wherein the first and second RATs are different, which, when executed by a processor, performs certain operations. The operations generally include receiving neighbor indication information about network service via the second RAT while communicating via the first RAT, scanning for the second RAT using the received information, and determining whether to handover to network service via the second RAT based on results of the scanning.

Certain embodiments of the present disclosure provide an apparatus for performing handover between network service via first and second RATs, wherein the first and second RATs are different. The apparatus generally includes means for receiving neighbor indication information about network service via the second RAT while communicating via the first RAT, means for scanning for the second RAT using the received information, and means for determining whether to handover to network service via the second RAT based on results of the scanning.

Certain embodiments of the present disclosure provide a receiver for wireless communication. The receiver generally includes communication logic configured to receive neighbor indication information about network service via a second ratio access technology (RAT) while communicating via the first RAT, wherein the first and second RATs are different; scanning logic configured to scan for the second RAT using the received information; and handover-determination logic configured to determine whether to handover to network service via the second RAT based on results of the scan.

Certain embodiments of the present disclosure provide a mobile device. The mobile device generally includes a receiver front end for communicating via a first RAT; communication logic configured to receive neighbor indication information about network service via a second RAT while communicating via the first RAT, wherein the first and second RATs are different; scanning logic configured to scan for the second RAT using the received information; and handover-determination logic configured to determine whether to handover to network service via the second RAT based on results of the scan.

Certain embodiments of the present disclosure provide a method for assisting handover between network service via first and second RATs, wherein the first and second RATs are different. The method generally includes communicating via the first RAT and transmitting information about network service via the second RAT.

Certain embodiments of the present disclosure provide a computer-readable medium containing a program for assisting handover between network service via first and second radio RATs, wherein the first and second RATs are different, which, when executed by a processor, performs certain operations. The operations generally include communicating via the first RAT and transmitting information about network service via the second RAT.

Certain embodiments of the present disclosure provide an apparatus for assisting handover between network service via first and second RATs. The apparatus generally includes means for communicating via the first RAT and means for transmitting information about network service via the second RAT, wherein the first and second RATs are different.

Certain embodiments of the present disclosure provide a transmitter for wireless communication. The transmitter generally includes communication logic configured to communicate via a first RAT and transmission logic configured to transmit information about network service via a second RAT, wherein the first and second RATs are different.

Certain embodiments of the present disclosure provide a base station. The base station generally includes communication logic configured to communicate via a first RAT and a transmitter front end for transmitting information about network service via a second RAT, wherein the first and second RATs are different.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device, in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology, in accordance with certain embodiments of the present disclosure.

FIG. 4A illustrates a mobility scenario where a dual-mode mobile station (MS) may move outside the coverage of a WiMAX network and enter the coverage of a CDMA EVDO/1x network, in accordance with certain embodiments of the present disclosure.

FIG. 4B illustrates a mobility scenario where a dual-mode MS may move outside the coverage of a CDMA EVDO network and enter the coverage of a WiMAX network, in accordance with certain embodiments of the present disclosure.

FIG. 5 is a flow chart of example operations for performing a base-station-assisted handover of a dual-mode MS from a WiMAX network to a CDMA EVDO or 1x network, from the perspective of the dual-mode MS, in accordance with certain embodiments of the present disclosure.

FIG. 5A is a block diagram of means corresponding to the example operations of FIG. 5 for performing a base-station-assisted handover of a dual-mode MS from a WiMAX network to a CDMA EVDO/1x network, from the perspective of the dual-mode MS, in accordance with certain embodiments of the present disclosure.

FIG. 6 illustrates an example CDMA Neighbor Indication message as a MAC management message including various elements in the payload of a Media Access Control (MAC) Protocol Data Unit (PDU), in accordance with certain embodiments of the present disclosure.

FIG. 7 illustrates example CDMA scanning intervals requested by an MS communicating using a WiMAX network service during the interleaving intervals, in accordance with certain embodiments of the present disclosure.

FIG. 8 is a flow chart of example operations for performing a base-station-assisted handover of a dual-mode MS from a WiMAX network to a CDMA EVDO or 1x network from the perspective of the WiMAX base station (BS), in accordance with certain embodiments of the present disclosure.

FIG. 8A is a block diagram of means corresponding to the example operations of FIG. 8 for performing a BS-assisted handover of a dual-mode MS from a WiMAX network to a CDMA EVDO/1x network from the perspective of the WiMAX BS, in accordance with certain embodiments of the present disclosure.

FIG. 9 illustrates a call flow of example operations for performing a BS-assisted handover from a WiMAX base station to a CDMA EVDO/1x base station, in accordance with certain embodiments of the present disclosure.

FIG. 10 is a flow chart of example operations for performing a BS-assisted handover of a dual-mode MS from a CDMA EVDO network to a WiMAX network from the perspective of the dual-mode MS, in accordance with certain embodiments of the present disclosure.

FIG. 10A is a block diagram of means corresponding to the example operations of FIG. 10 for performing a BS-assisted handover of a dual-mode MS from a CDMA EVDO network to a WiMAX network from the perspective of the dual-mode MS, in accordance with certain embodiments of the present disclosure.

FIG. 11 is a flow chart of example operations for performing a BS-assisted handover of a dual-mode MS from a CDMA EVDO network to a WiMAX network from the perspective of the CDMA BS, in accordance with certain embodiments of the present disclosure.

FIG. 11A is a block diagram of means corresponding to the example operations of FIG. 11 for performing a BS-assisted handover of a dual-mode MS from a CDMA EVDO network to a WiMAX network from the perspective of the CDMA BS, in accordance with certain embodiments of the present disclosure.

FIG. 12 illustrates a call flow of example operations for performing a BS-assisted handover from a CDMA EVDO base station to a WiMAX base station, in accordance with certain embodiments of the present disclosure.

### DETAILED DESCRIPTION

Certain embodiments of the present disclosure provide methods and apparatus for base-station-assisted handover between WiMAX and CDMA EVDO/1x networks during normal operation of a dual-mode mobile station (MS). By having a base station (BS) using one radio access technology (RAT) broadcast information about a BS in a neighboring cell employing a different RAT, the methods and apparatus may improve service continuity during handover.

### Exemplary Wireless Communication System

The methods and apparatus of the present disclosure may be utilized in a broadband wireless communication system. The term “broadband wireless” refers to technology that provides wireless, voice, Internet, and/or data network access over a given area.

WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

Mobile WiMAX is based on OFDM (orthogonal frequency-division multiplexing) and OFDMA (orthogonal frequency division multiple access) technology. OFDM is a digital multi-carrier modulation technique that has recently found wide adoption in a variety of high-data-rate communication systems. With OFDM, a transmit bit stream is divided into multiple lower-rate substreams. Each substream is modulated with one of multiple orthogonal subcarriers and sent over one of a plurality of parallel subchannels. OFDMA is a multiple access technique in which users are assigned subcarriers in different time slots. OFDMA is a flexible multiple-access technique that can accommodate many users with widely varying applications, data rates, and quality of service requirements.

The rapid growth in wireless internets and communications has led to an increasing demand for high data rate in the field of wireless communications services. OFDM/OFDMA systems are today regarded as one of the most promising research areas and as a key technology for the next generation of wireless communications. This is due to the fact that OFDM/OFDMA modulation schemes can provide many advantages such as modulation efficiency, spectrum efficiency, flexibility, and strong multipath immunity over conventional single carrier modulation schemes.

IEEE 802.16x is an emerging standard organization to define an air interface for fixed and mobile broadband wireless access (BWA) systems. IEEE 802.16x approved “IEEE P802.16-REVd/D5-2004” in May 2004 for fixed BWA systems and published “IEEE P802.16e/D12 Oct. 2005” in October 2005 for mobile BWA systems. Those two standards defined four different physical layers (PHYs) and one media access control (MAC) layer. The OFDM and OFDMA physical layer of the four physical layers are the most popular in the fixed and mobile BWA areas respectively.

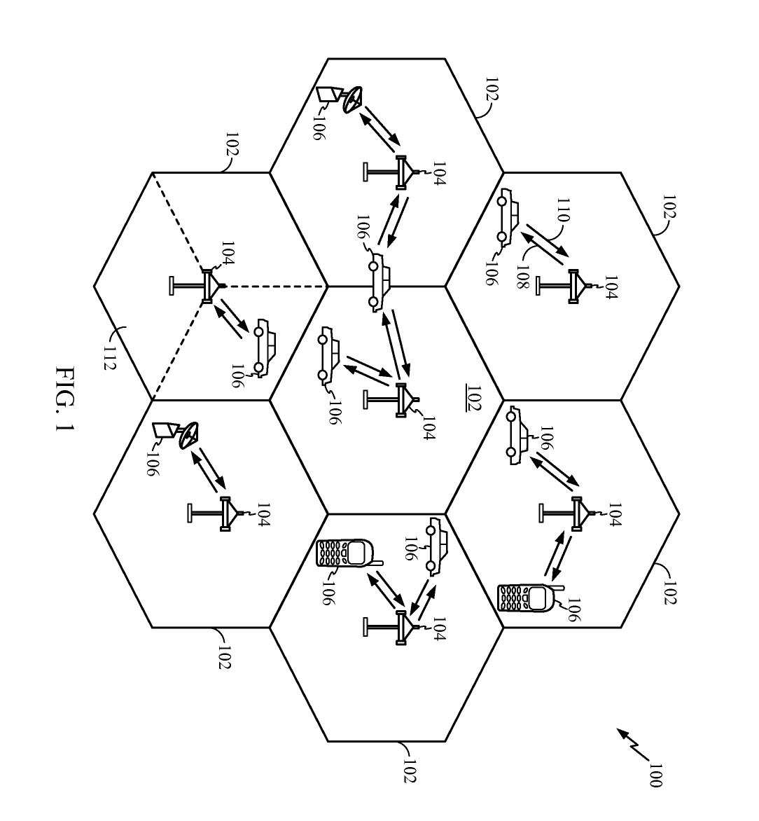

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

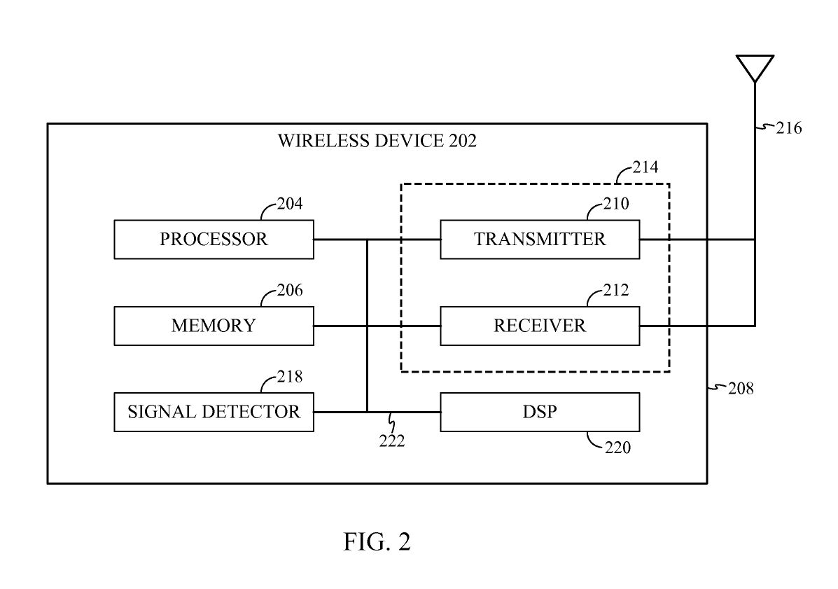

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

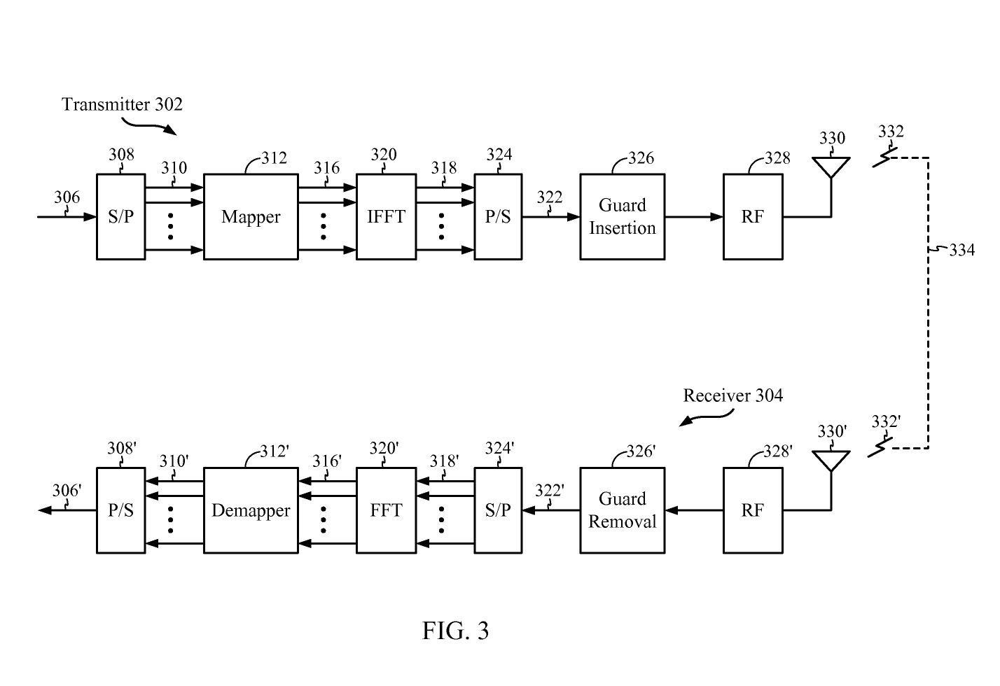

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

Exemplary Handover from WiMAX to CDMA

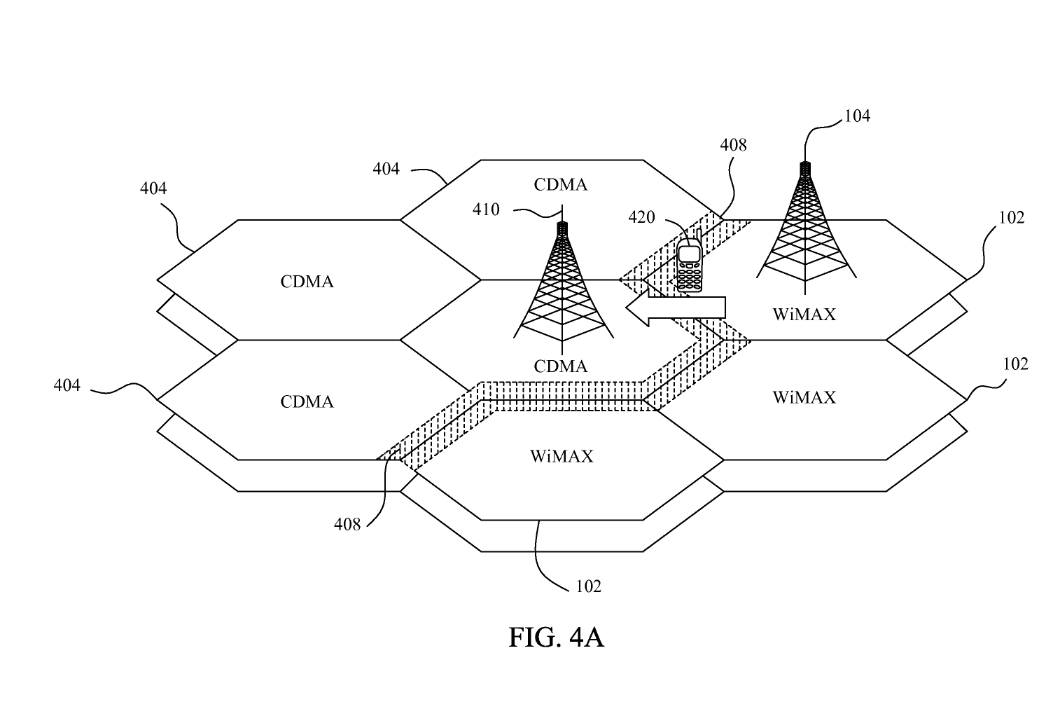

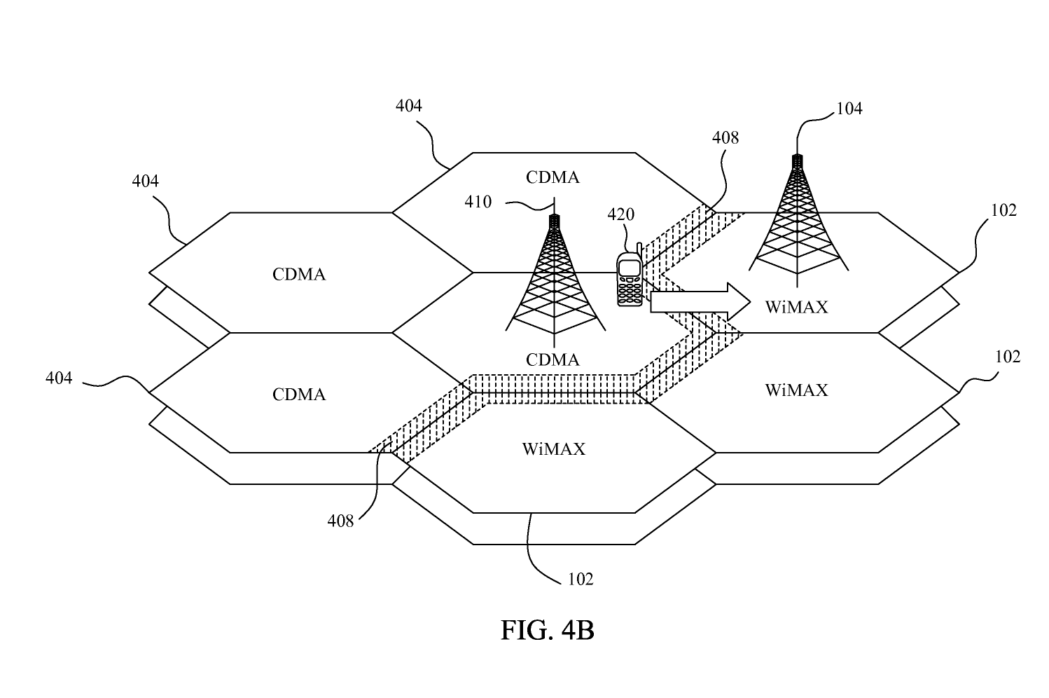

FIG. 4A illustrates a mobility scenario where WiMAX cells 102 are adjacent to Code Division Multiple Access (CDMA) cells 404. At least some of the WiMAX cells 102 may also provide coverage for CDMA signals, but for purposes of certain embodiments in the present disclosure, the cells 102 currently utilize WiMAX for communicating with a user terminal. Each WiMAX cell 102 typically has a WiMAX base station (BS) 104 to facilitate WiMAX network communications with a user terminal, such as a dual-mode mobile station (MS) 420. As used herein, a dual-mode MS generally refers to an MS that is capable of processing two different radio access technologies (RATs), such as both WiMAX and CDMA signals. Similar to a WiMAX cell 102, each CDMA cell 404 typically has a CDMA BS 410 in order to facilitate CDMA Evolution-Data Optimized (EVDO) or 1 times Radio Transmission Technology (1xRTT, or simply 1x) communications, for example, with a user terminal, such as the dual-mode MS 420.

As illustrated by the mobility scenario of FIG. 4A, the MS 420 may move outside the coverage area of a WiMAX BS 104 and enter the coverage area of a CDMA BS 410. While transitioning from a WiMAX cell 102 to a CDMA cell 404, the MS 420 may enter a coverage overlap area 408 where the MS is able to receive signals from both networks.

It is during this transition that the MS may implement a handover process from a WiMAX BS to a CDMA BS. In addition to the normal difficulties associated with handover between two BSs of the same network type, handover between two BSs of different network types, such as from WiMAX to CDMA EVDO/1x, presents further challenges to service continuity, which are particularly acute if the MS is in the process of data transfer when the handover occurs. This is because the core networks of neighboring WiMAX and CDMA EVDO/1x networks do not currently support an interface for true seamless hard handoff. Accordingly, there is a need for techniques and apparatus such that a dual-mode MS may quickly perform a handover from the WiMAX network to the CDMA network while minimizing service disruption.

Embodiments of the present disclosure provide methods and apparatus allowing a dual-mode MS to handover from a WiMAX network to a CDMA EVDO/1x network based on CDMA Neighbor Indication Information provided by a WiMAX BS. Such techniques may increase service continuity while the MS moves from WiMAX to CDMA network coverage.

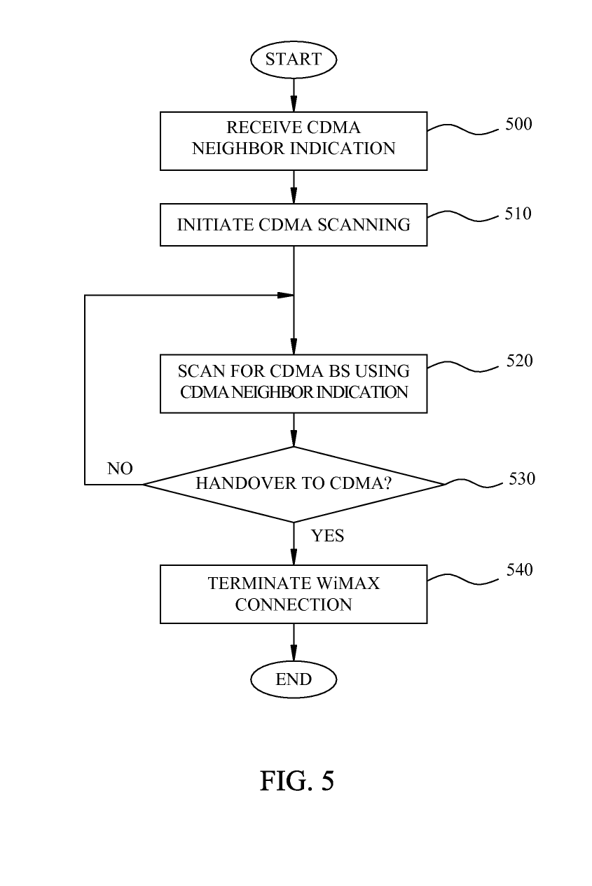

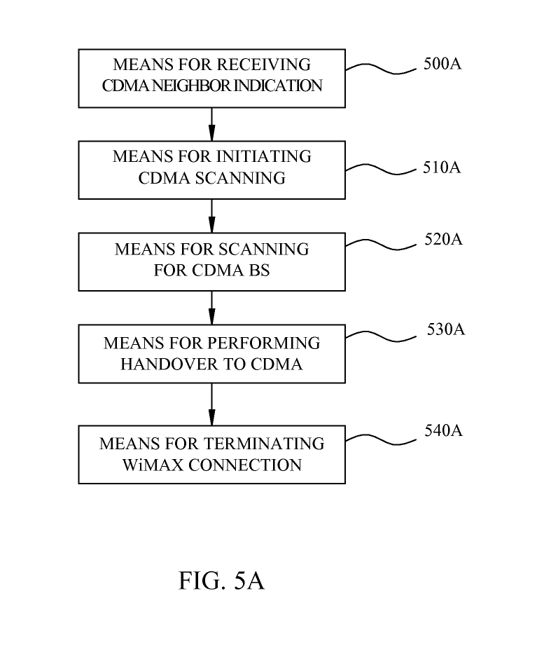

FIG. 5 depicts a flowchart of example operations for such BS-assisted handover from WiMAX network service to CDMA EVDO/1x network service from the perspective of a dual-mode MS 420. The operations may begin, at 500, by receiving CDMA Neighbor Indication information broadcast from the WiMAX BS. The CDMA Neighbor Indication information may be a newly defined broadcast Media Access Control (MAC) management message or a new information element (IE) in an existing WiMAX MAC management message, such as in the Downlink Channel Descriptor (DCD) and/or Uplink Channel Descriptor (UCD) messages. The CDMA Neighbor Indication information may indicate one or multiple candidate CDMA EVDO/1x BSs to which the MS may be handed over.

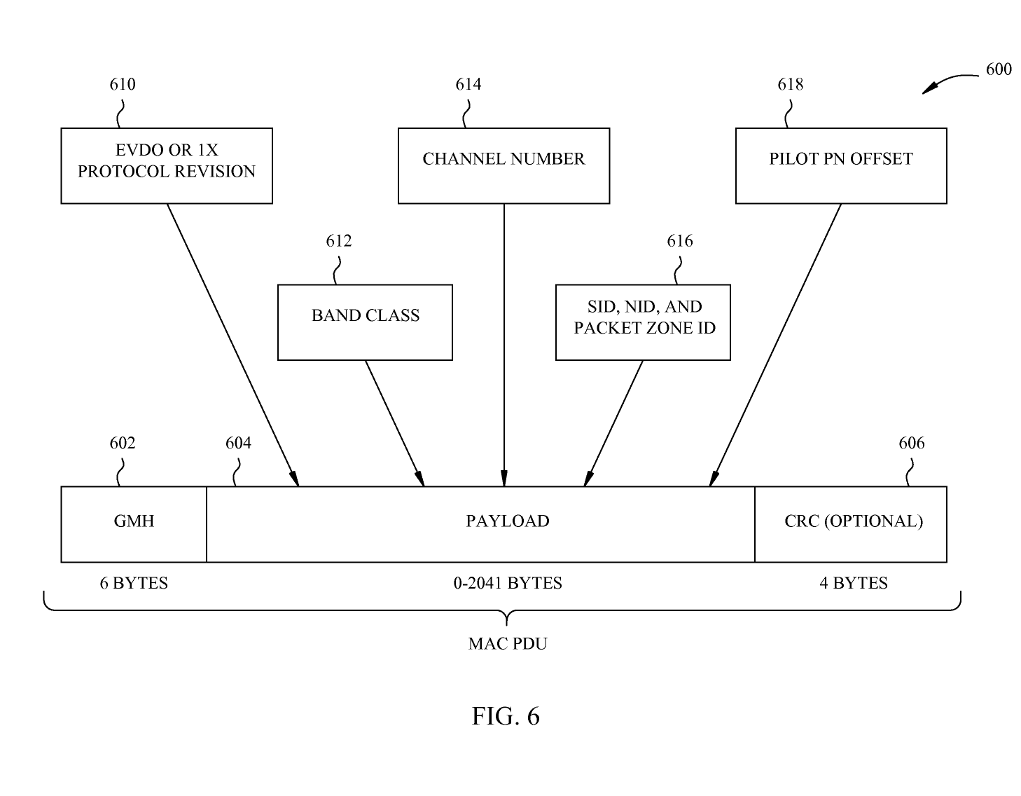

Referring now to FIG. 6 for some embodiments, the CDMA Neighbor Indication information may be included in a newly defined CDMA Neighbor Indication MAC management message broadcast as a MAC Protocol Data Unit (PDU) 600. For some embodiments, the CDMA Neighbor Indication MAC management message may be fragmented into a plurality of MAC PDUs. A typical MAC PDU 600 may consist of three components: a generic MAC header (GMH) 602 having a length of 6 bytes and containing PDU control information, a variable length PDU body known as the payload 604 containing information specific to the PDU type, and an optional frame check sequence (FCS), which may contain an IEEE 32-bit (4-byte) cyclic redundancy check (CRC) 606 code.

Containing the actual MAC management message (e.g., the CDMA Neighbor Indication information), the payload 604 may vary in length from 0 to 2041 bytes if there is no CRC present or may vary from 0 to 2037 bytes with the CRC 606 present. For OFDMA, the CRC 606 is typically mandatory. For the CDMA Neighbor Indication MAC management message, the payload 604 may comprise the following information per neighbor CDMA channel: the CDMA EVDO/1× protocol revision 610; the Band Class 612; the Channel Number 614; the System Identification Number (SID), the Network Identification Number (NID), and the Packet Zone ID 616; and the Pilot Pseudo Noise (PN) Offset 618.

Returning to FIG. 5, once CDMA Neighbor Indication information is received, the dual-mode MS may initiate scanning at 510. In order to scan the CDMA EVDO/1x network without losing data packets in the WiMAX network, any current data transmissions may be temporarily suspended. Thus, to initiate scanning, the MS may request suspension of any current data transmission with the WiMAX network by sending a Scanning Interval Allocation Request (MOB_SCN-REQ) message to the WiMAX BS in an effort to notify the BS of certain time intervals when the MS may be unavailable for communication with the WiMAX network in order to scan the CDMA EVDO/1x network.

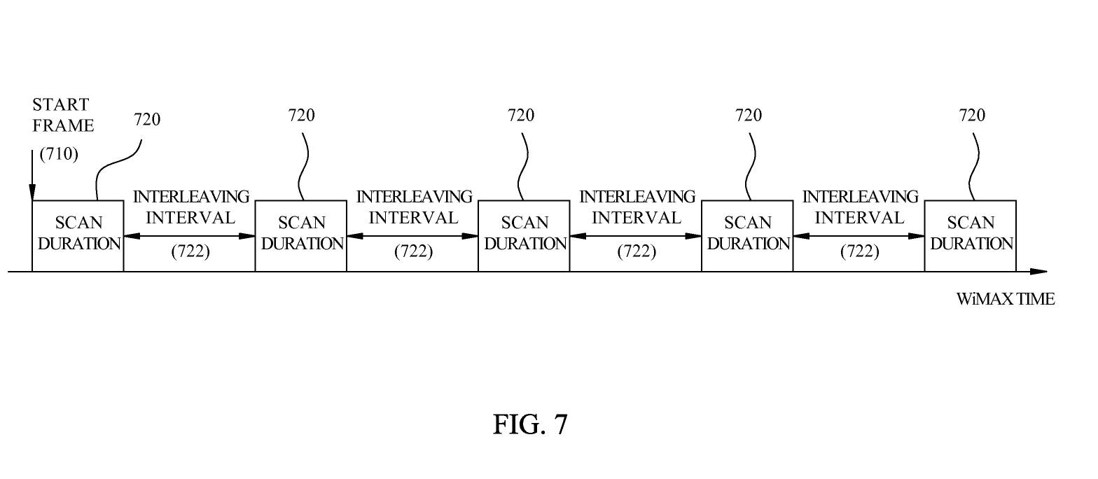

The MOB_SCN-REQ message may comprise parameters such as scan duration, interleaving interval, and scan iteration. The scan duration may be the duration (in units of OFDM/OFDMA frames) of the requested scanning period, the interleaving interval may be the period of MS normal operations interleaved between scanning durations, and the scan iteration may be the requested number of iterating scanning interval(s) by an MS. These parameters are discussed in greater detail below with respect to FIG. 7.

Once the scanning request is granted (i.e., the dual-mode MS receives a Scanning Interval Allocation Response (MOB_SCN-RSP) message from the WiMAX BS), the MS may proceed to scan the EVDO or 1x network for CDMA BSs at 520 using the CDMA Neighbor Indication information previously received. With this detailed information, the MS may quickly search for a CDMA BS pilot channel from one or more EVDO or 1x BSs, measure the channel quality condition, and/or read the sector parameter or the system parameter message on the CDMA EVDO/1x control channel in an effort to prepare for, and thereby speed up, the handover process.

FIG. 7 illustrates the scanning intervals in which the MS performs the CDMA EVDO or 1x network scan. Upon receiving CDMA Neighbor Indication information at 500 and initiating CDMA scanning at 510, the MS may begin scanning for CDMA base stations at the Start Frame 710. Thereafter, the MS may scan for CDMA networks for a predetermined scan duration 720 at the end of which, the MS may discontinue the scan for a predetermined interleaving interval 722 and resume normal operation with data exchange. This alternating pattern of scanning and interleaving may continue until the end of the requested CDMA BS scan. Rather than multiple scan iterations, the MOB_SCN-REQ scan iteration parameter may indicate a single scan iteration for some embodiments. In such cases, the scan for CDMA BSs may only include a single scan duration.

Depending on the results of the CDMA BS scan, the MS may determine whether to initiate a handover to a CDMA BS at 530 and may select an appropriate CDMA EVDO/1x BS for handover. For an MS supporting Hard Handoff (HHO), a decision to perform a handover may be made when the serving WiMAX BS has a mean carrier-to-interference-plus-noise ratio (CINR) less than a first threshold, a mean received signal strength indicator (RSSI) less than a second threshold, and/or a BS round trip delay (RTD) more than a third threshold. For a WiMAX MS that supports Fast Base Station Switching (FBSS) or Macro Diversity Handover (MDHO), handover may be triggered when all WiMAX BSs in the diversity set are about to drop, namely with mean CINR less than H_Delete. If the MS decides not to perform a handover to the selected CDMA BS, the MS may resume scanning for CDMA BSs at 520.

If the decision to perform a handover to the selected CDMA BS is made at 530, then during handover, the MS may signal intent to enter an idle state by sending a De-registration Request (DREG-REQ) message to the serving WiMAX BS. Upon receiving a response from the WiMAX BS (e.g., a De-register Command (DREG-CMD) message) or a timeout, the MS may terminate connection with the WiMAX BS at 540. After terminating the data connection, the MS may start accessing and setting up a new data session and connection with the selected CDMA EVDO/1x BS. However, if the handover to the CDMA EVDO/1x network fails before a predetermined deadline, the dual-mode MS may still return to the WiMAX network using the procedure for network reentry after idle mode as specified in the WiMAX standards in an effort to resume the previous data session.

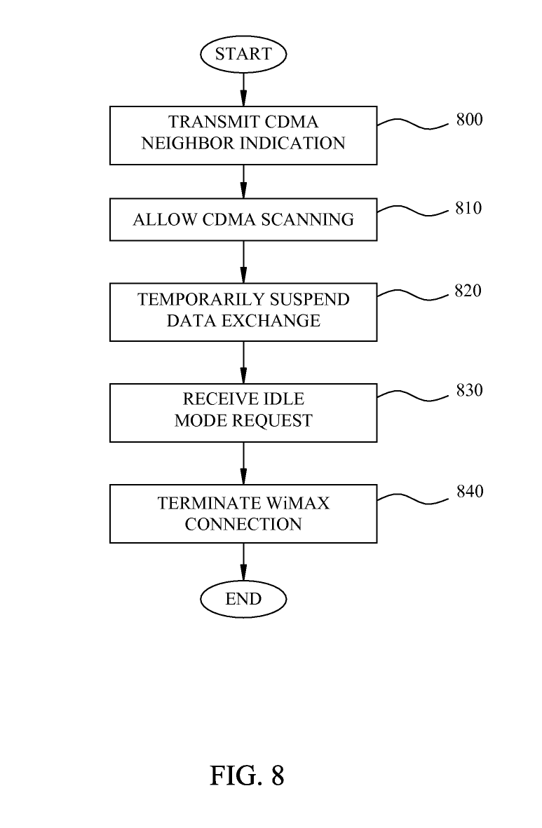

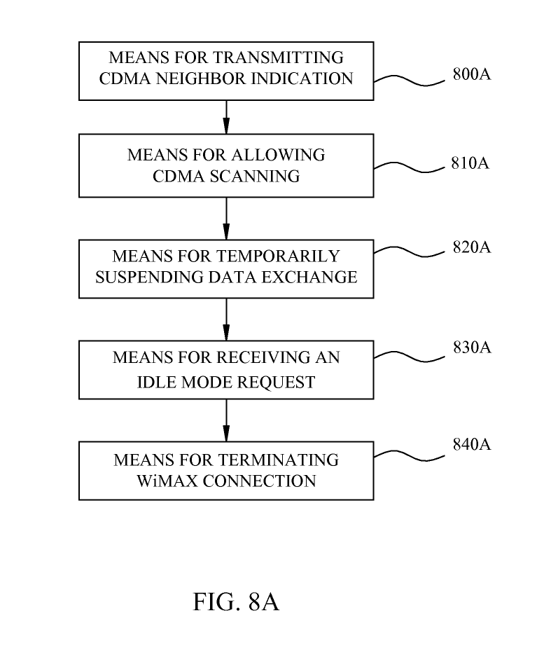

Now that BS-assisted handover has been described above from the perspective of a dual-mode MS 420, FIG. 8 portrays a flow chart of example operations for performing a BS-assisted handover from a WiMAX network to a CDMA EVDO or 1x network from the perspective of a WiMAX BS 104. The operations may begin, at 800, by transmitting CDMA Neighbor Indication information such that one or more mobile stations may receive this information. As described above, the CDMA Neighbor Indication information may be a newly defined MAC management message (as illustrated in FIG. 6 and described above) or a new IE in an existing WiMAX MAC management message, such as in the DCD and/or UCD messages. The CDMA Neighbor Indication information may indicate one or multiple candidate CDMA EVDO/1x BSs to which the MS may be handed over.

After receiving a Scanning Interval Allocation Request (MOB_SCN-REQ) message, the WiMAX BS may respond with a Scanning Interval Allocation Response (MOB_SCN-RSP) message. The MOB_SCN-RSP message may either grant or deny the scanning request. If the WiMAX BS allows CDMA scanning at 810, then at 820, the WiMAX BS may temporarily suspend data exchange with the dual-mode MS 420, during the requested scan durations 720 as illustrated in FIG. 7, in an effort to allow the dual-mode MS 420 to scan the CDMA EVDO or 1x network. Once an idle mode request (e.g., DREG-REQ) is received at 830, then the WiMAX BS may terminate the WiMAX connection with the dual-mode MS at 840.

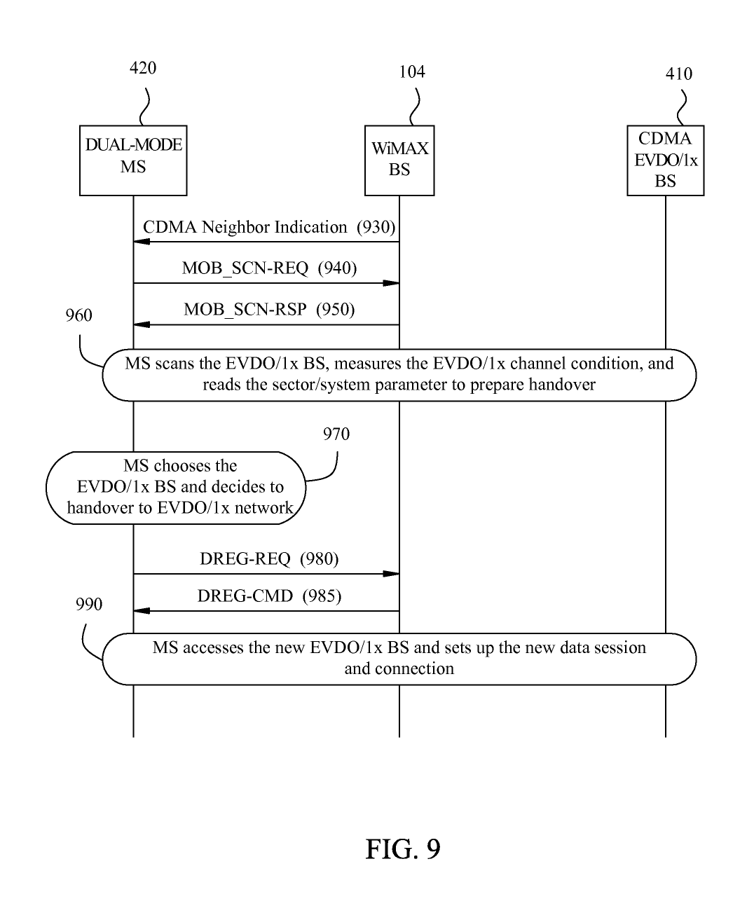

FIG. 9 further illustrates the BS-assisted WiMAX to CDMA EVDO/1x handover procedure and details the interaction between the dual-mode MS 420, the WiMAX BS 104, and the CDMA BS 410. As stated previously, the WiMAX to CDMA EVDO/1x handover process may begin with the MS receiving CDMA Neighbor Indication information from the WiMAX BS at 930. The MS may then send a Scanning Interval Allocation Request (MOB_SCN-REQ) to the WiMAX BS at 940. At 950, the WiMAX BS may respond with a Scanning Interval Allocation Response (MOB_SCN-RSP) granting the request. Thereafter, the MS may scan the CDMA EVDO/1x BSs using the CDMA Neighbor Indication information, measure the CDMA EVDO/1x channel condition, and read the sector/system parameter for handover preparation at 960. When a trigger for actual handover is received at 970, the MS may send a De-registration Request (DREG-REQ) to the WiMAX BS at 980. In response at 985, the WiMAX BS may send a De-register Command (DREG-CMD) to instruct the MS to terminate normal operations with the WiMAX BS. The MS may then access the new CDMA EVDO/1x BS and may set up a new data session and connection at 990.

Exemplary Handover from CDMA to WiMAX

FIG. 4B illustrates a mobility scenario where CDMA cells 404 are adjacent to WiMAX cells 102. At least some of the CDMA cells 404 may also provide coverage for WiMAX signals, but for purposes of certain embodiments in the present disclosure, the CDMA cells 404 may currently utilize CDMA Evolution-Data Optimized (EVDO) for communicating with a user terminal, such as a dual-mode MS 420. Each CDMA cell 404 typically has a CDMA BS 410 to facilitate CDMA EVDO network communications with the dual-mode MS 420.

As illustrated by the mobility scenario of FIG. 4B, the MS 420 may move outside the coverage area of a CDMA BS 410 and enter the coverage area of a WiMAX BS 104. While transitioning from a CDMA cell 404 to a WiMAX cell 102, the MS 420 may enter a coverage overlap area 408 where the MS is able to receive signals from both networks.

It is during this transition that the MS may implement a handover process from a CDMA BS to a WiMAX BS. In addition to the normal difficulties associated with handover between two BSs of the same network type, handover between two BSs of different network types, such as from CDMA EVDO to WiMAX, presents further challenges to service continuity, which are particularly acute if the MS is in the process of data transfer when the handover occurs. This is because the core networks of neighboring CDMA EVDO and WiMAX networks do not currently support an interface for true seamless hard handoff. Accordingly, there is a need for techniques and apparatus such that a dual-mode MS may quickly perform a handover from a CDMA EVDO network to a WiMAX network while minimizing service disruption.

Embodiments of the present disclosure provide methods and apparatus allowing a dual-mode MS to handover from a CDMA EVDO network to a WiMAX network based on WiMAX Neighbor Indication Information provided by a CDMA BS. Such techniques may increase service continuity while the MS moves from CDMA to WiMAX network coverage.

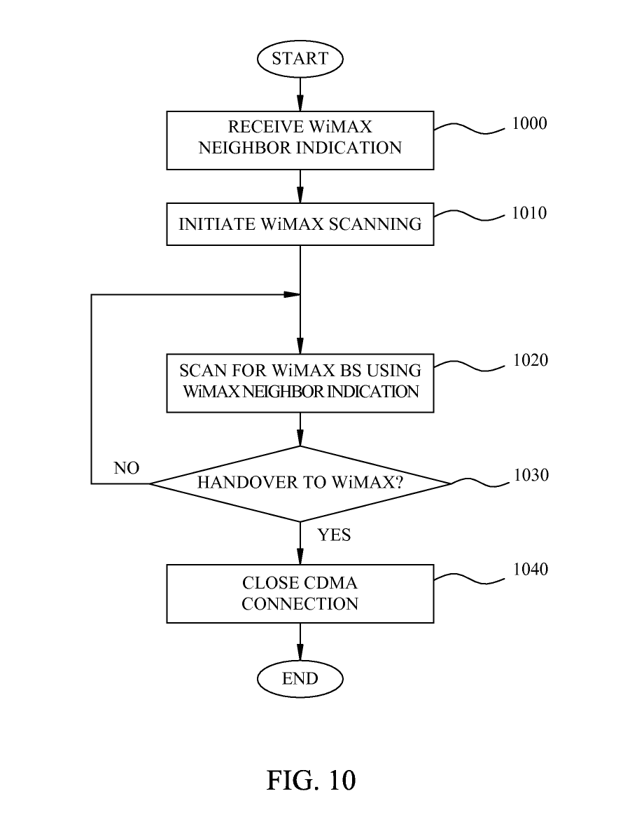

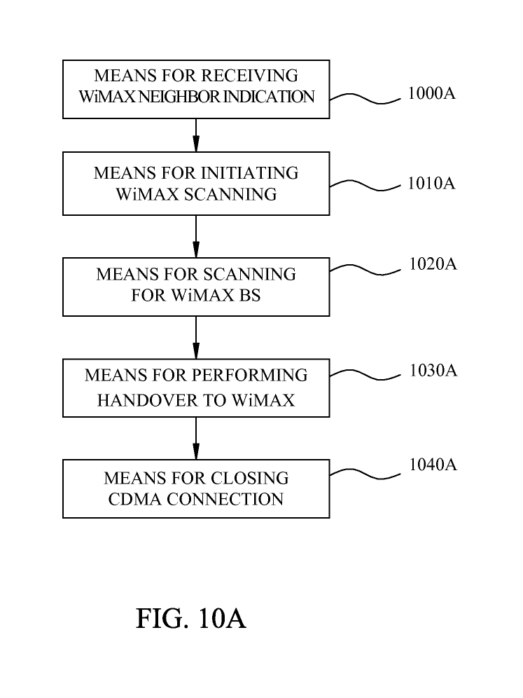

FIG. 10 shows a flowchart of example operations for such BS-assisted handover from CDMA EVDO network service to WiMAX network service from the perspective of a dual-mode MS 420. The operations may begin, at 1000, by receiving WiMAX Neighbor Indication information broadcast from a CDMA BS aware of one or more neighbor WiMAX BSs. Broadcast as a new sector broadcast message, for example, the WiMAX Neighbor Indication information may indicate one or multiple candidate WiMAX BSs to which the MS may be handed over. The WiMAX Neighbor Indication information may include the following information per neighbor WiMAX segment: the Frequency Assignment (FA) index, the bandwidth, the FFT size, the OFDM/OFDMA frame duration, the ratio of cyclic prefix (CP), the operator ID, and the preamble index.

Once WiMAX Neighbor Indication information is received, the dual-mode MS may initiate a WiMAX network scan at 1010. In order to scan the WiMAX network without losing data packets in the CDMA EVDO network, any current data transmissions may be temporarily suspended. Thus, to initiate WiMAX scanning, the MS may request suspension of any current data transmission with the CDMA EVDO network by sending “null cover” as the Data Rate Control (DRC) cover to the CDMA BS in an effort to notify the BS that the MS may be unavailable for communication with the CDMA EVDO network in order to scan the WiMAX network.

After sending a DRC cover to the CDMA EVDO BS, the MS may scan the WiMAX network at 1020 using the WiMAX Neighbor Indication information previously received. With this detailed information, the MS may quickly search for a WiMAX BS preamble, measure the channel quality condition, and/or acquire the Downlink Channel Descriptor (DCD) and the Uplink Channel Descriptor (UCD) messages in an effort to prepare for, and thereby speed up, the handover process.

Following the scan, the MS may notify the CDMA EVDO BS of completion of the scanning process by sending a DRC Cover=Sector Cover message to the CDMA EVDO BS. Additionally, one or more new candidate WiMAX BS(s) may be added into the candidate set.

Depending on the results of the WiMAX BS scan, the MS may determine whether to initiate a handover to a WiMAX BS at 1030 and may select an appropriate WiMAX BS for handover. If there is more than one candidate WiMAX BS to which the MS may be handed over, the most proper WiMAX BS may be chosen based on the strongest received signal power (i.e., RSSI) or the maximum CINR. For example, handover may occur when all the pilots in the active set are about to be dropped. If the MS decides not to perform a handover to the selected WiMAX BS, the MS may resume scanning for WiMAX BSs at 1020.

If the decision to perform a handover to the selected WiMAX BS is made at 1030, then during handover, the MS may send a Connection Close message to the CDMA BS at 1040 in an effort to have the data connection with the CDMA EVDO network closed and to enter a dormant state. After closing the CDMA connection at 1040, the MS may start accessing and setting up a new data session and connection with the selected WiMAX BS. However, if the handover to the WiMAX network fails before a predetermined deadline, the MS may still return to the CDMA EVDO network using the reactivation from dormancy procedure as specified in the CDMA EVDO standards to resume the previous data session.

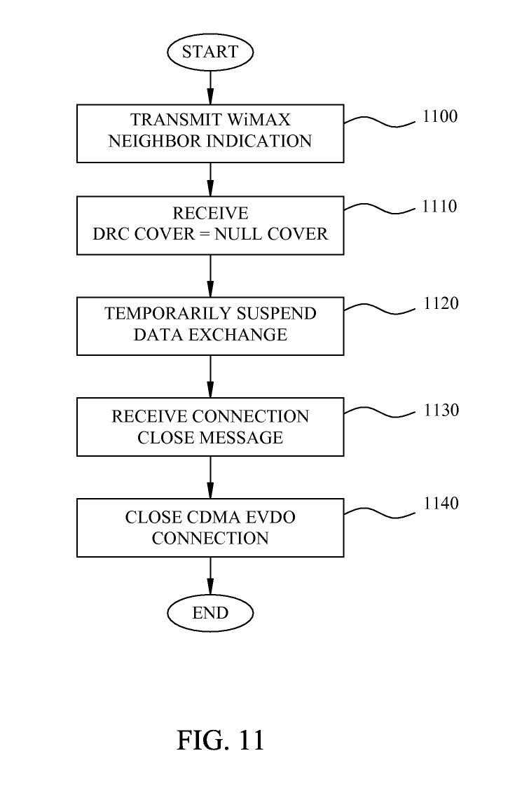

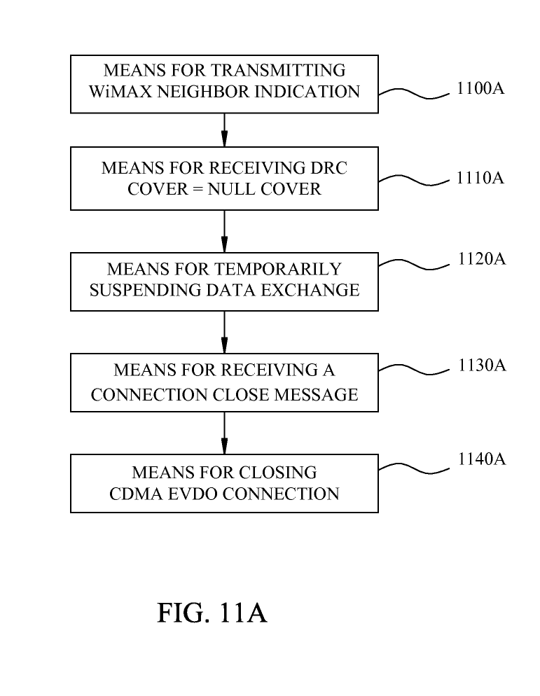

Now that BS-assisted handover has been described above from the perspective of a dual-mode MS 420, FIG. 11 portrays a flow chart of example operations for performing a BS-assisted handover from a CDMA EVDO network to a WiMAX network from the perspective of a CDMA BS 410. The operations may begin, at 1100, by transmitting WiMAX Neighbor Indication information such that one or more mobile stations may receive this information. As described above, the WiMAX Neighbor Indication information may be transmitted as a sector broadcast message. The WiMAX Neighbor Indication information may indicate one or multiple candidate WiMAX BSs to which the MS may be handed over.

After receiving a DRC cover equal to “null cover” at 1110, the CDMA BS may temporarily suspend data exchange with the dual-mode MS 420 at 1120 in an effort to allow the MS to scan for WiMAX BSs. Once a Connection Close message is received at 1130, then the CDMA BS may terminate the EVDO connection with the dual-mode MS 420 at 1140.

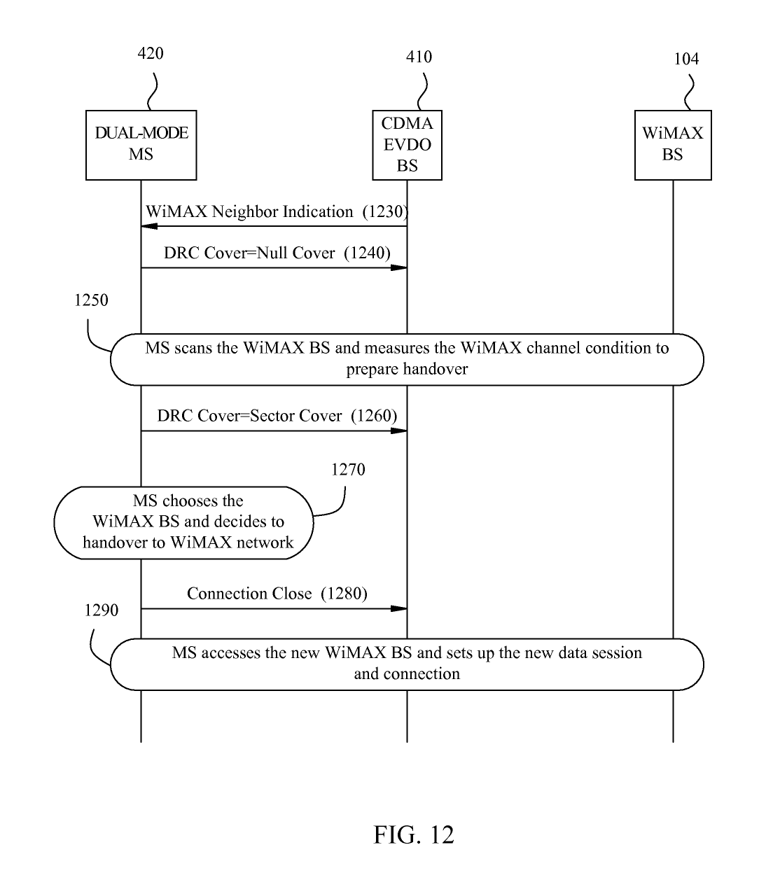

FIG. 12 further illustrates the BS-assisted CDMA EVDO to WiMAX handover procedure and details the interaction between the dual-mode MS 420, the CDMA BS 410, and the WiMAX BS 104. As described above, the CDMA EVDO to WiMAX handover process may begin when the MS receives WiMAX Neighbor Indication information from the CDMA BS at 1230. At 1240, the MS may send a DRC Cover=Null Cover message to request the CDMA EVDO BS to allow scanning for WiMAX base stations and to temporarily suspend data exchanges with the EVDO network. At 1250, the MS may scan the WiMAX BSs using the WiMAX Neighbor Indication information and may measure the WiMAX channel condition for handover preparation. Following the WiMAX scanning, the MS may notify the CDMA EVDO BS of completion of the scanning process by sending a DRC Cover=Sector Cover message to the CDMA EVDO BS at 1260. Upon selecting one of the candidate WiMAX BSs and deciding to perform a handover to the WiMAX network at 1270, the MS may send a Connection Close message at 1280 to the CDMA BS. The MS may then access the new WiMAX BS and may set up a new data session and connection at 1290.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 500-540 illustrated in FIG. 5 correspond to means-plus-function blocks 500A-540A illustrated in FIG. 5A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside (e.g., stored, encoded, etc.) in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as instructions or as one or more sets of instructions on a computer-readable medium or storage medium. A storage media may be any available media that can be accessed by a computer or by one or more processing devices. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for performing handover between network service via first and second radio access technologies (RATs), comprising:
while communicating via the first RAT, receiving neighbor indication information about network service via the second RAT, wherein the first and second RATs are different;
scanning for the second RAT using the received information; and
determining whether to handover to network service via the second RAT based on results of the scanning.

2. The method of claim 1, wherein the first RAT is WiMAX (Worldwide Interoperability for Microwave Access), the second RAT is CDMA (Code Division Multiple Access), and the received information is CDMA Neighbor Indication information.

3. The method of claim 2, wherein the second RAT is CDMA Evolution-Data Optimized (EVDO) or CDMA 1x.

4. The method of claim 2, wherein the CDMA Neighbor Indication information is a new information element (IE) in an existing Media Access Control (MAC) management message.

5. The method of claim 4, wherein the existing MAC management message is at least one of a Downlink Channel Descriptor (DCD) message or an Uplink Channel Descriptor (UCD) message.

6. The method of claim 2, wherein the CDMA Neighbor Indication information is a newly defined Media Access Control (MAC) management message.

7. The method of claim 6, wherein the CDMA Neighbor Indication information comprises at least one of a CDMA protocol revision, a band class, a channel number, a system identification number (SID), a network identification number (NID), a packet zone identifier (ID), and a pilot pseudo noise (PN) offset.

8. The method of claim 1, wherein the first RAT is CDMA (Code Division Multiple Access), the second RAT is WiMAX (Worldwide Interoperability for Microwave Access), and the received information is WiMAX Neighbor Indication information.

9. The method of claim 8, wherein the first RAT is CDMA Evolution-Data Optimized (EVDO).

10. The method of claim 8, wherein a new sector broadcast message comprises the WiMAX Neighbor Indication information.

11. The method of claim 8, wherein the WiMAX Neighbor Indication information comprises at least one of a frequency assignment (FA) index, a bandwidth, a fast Fourier transform (FFT) size, an orthogonal frequency-division multiplexing (OFDM) or orthogonal frequency division multiple access (OFDMA) frame duration, a ratio of cyclic prefix (CP), an operator identifier (ID), and a preamble index.

12. A computer-program apparatus for performing handover between network service via first and second radio access technologies (RATs) comprising a computer readable medium having instructions stored thereon, the instructions being executable by one or more processors and the instructions comprising:
instructions for, while communicating via the first RAT, receiving neighbor indication information about network service via the second RAT, wherein the first and second RATs are different;
instructions for scanning for the second RAT using the received information; and
instructions for determining whether to handover to network service via the second RAT based on results of the scanning.

13. The computer-program apparatus of claim 12, wherein the first RAT is WiMAX (Worldwide Interoperability for Microwave Access), the second RAT is CDMA (Code Division Multiple Access), and the received information is CDMA Neighbor Indication information.

14. The computer-program apparatus of claim 13, wherein the second RAT is CDMA Evolution-Data Optimized (EVDO) or CDMA 1x.

15. The computer-program apparatus of claim 13, wherein the CDMA Neighbor Indication information is a new information element (IE) in an existing Media Access Control (MAC) management message.

16. The computer-program apparatus of claim 15, wherein the existing MAC management message is at least one of a Downlink Channel Descriptor (DCD) message or an Uplink Channel Descriptor (UCD) message.

17. The computer-program apparatus of claim 13, wherein the CDMA Neighbor Indication information is a newly defined Media Access Control (MAC) management message.

18. The computer-program apparatus of claim 17, wherein the CDMA Neighbor Indication information comprises at least one of a CDMA protocol revision, a band class, a channel number, a system identification number (SID), a network identification number (NID), a packet zone identifier (ID), and a pilot pseudo noise (PN) offset.

19. The computer-program apparatus of claim 12, wherein the first RAT is CDMA (Code Division Multiple Access), the second RAT is WiMAX (Worldwide Interoperability for Microwave Access), and the received information is WiMAX Neighbor Indication information.

20. The computer-program apparatus of claim 19, wherein the first RAT is CDMA Evolution-Data Optimized (EVDO).

21. The computer-program apparatus of claim 19, wherein a new sector broadcast message comprises the WiMAX Neighbor Indication information.

22. The computer-program apparatus of claim 19, wherein the WiMAX Neighbor Indication information comprises at least one of a frequency assignment (FA) index, a bandwidth, a fast Fourier transform (FFT) size, an orthogonal frequency-division multiplexing (OFDM) or orthogonal frequency division multiple access (OFDMA) frame duration, a ratio of cyclic prefix (CP), an operator identifier (ID), and a preamble index.

23. An apparatus for performing handover between network service via first and second radio access technologies (RATs), comprising:
means for receiving neighbor indication information about network service via the second RAT while communicating via the first RAT, wherein the first and second RATs are different;
means for scanning for the second RAT using the received information; and
means for determining whether to handover to network service via the second RAT based on results of the scanning.

24. The apparatus of claim 23, wherein the first RAT is WiMAX (Worldwide Interoperability for Microwave Access), the second RAT is CDMA (Code Division Multiple Access), and the received information is CDMA Neighbor Indication information.

25. The apparatus of claim 24, wherein the second RAT is CDMA Evolution-Data Optimized (EVDO) or CDMA 1x.

26. The apparatus of claim 24, wherein the CDMA Neighbor Indication information is a new information element (IE) in an existing Media Access Control (MAC) management message.

27. The apparatus of claim 26, wherein the existing MAC management message is at least one of a Downlink Channel Descriptor (DCD) message or an Uplink Channel Descriptor (UCD) message.

28. The apparatus of claim 24, wherein the CDMA Neighbor Indication information is a newly defined Media Access Control (MAC) management message.

29. The apparatus of claim 28, wherein the CDMA Neighbor Indication information comprises at least one of a CDMA protocol revision, a band class, a channel number, a system identification number (SID), a network identification number (NID), a packet zone identifier (ID), and a pilot pseudo noise (PN) offset.

30. The apparatus of claim 23, wherein the first RAT is CDMA (Code Division Multiple Access), the second RAT is WiMAX (Worldwide Interoperability for Microwave Access), and the received information is WiMAX Neighbor Indication information.

31. The apparatus of claim 30, wherein the first RAT is CDMA Evolution-Data Optimized (EVDO).

32. The apparatus of claim 30, wherein the means for receiving is configured to receive a new sector broadcast message that includes the WiMAX Neighbor Indication information.

33. The apparatus of claim 30, wherein the WiMAX Neighbor Indication information comprises at least one of a frequency assignment (FA) index, a bandwidth, a fast Fourier transform (FFT) size, an orthogonal frequency-division multiplexing (OFDM) or orthogonal frequency division multiple access (OFDMA) frame duration, a ratio of cyclic prefix (CP), an operator identifier (ID), and a preamble index.

34. A receiver for wireless communication, comprising:
communication logic configured to receive neighbor indication information about network service via a second ratio access technology (RAT) while communicating via the first RAT, wherein the first and second RATs are different;
scanning logic configured to scan for the second RAT using the received information; and
handover-determination logic configured to determine whether to handover to network service via the second RAT based on results of the scan.

35. The receiver of claim 34, wherein the first RAT is WiMAX (Worldwide Interoperability for Microwave Access), the second RAT is CDMA (Code Division Multiple Access), and the received information is CDMA Neighbor Indication information.

36. The receiver of claim 35, wherein the second RAT is CDMA Evolution-Data Optimized (EVDO) or CDMA 1x.

37. The receiver of claim 35, wherein the CDMA Neighbor Indication information is a new information element (IE) in an existing Media Access Control (MAC) management message.

38. The receiver of claim 37, wherein the existing MAC management message is at least one of a Downlink Channel Descriptor (DCD) message or an Uplink Channel Descriptor (UCD) message.

39. The receiver of claim 35, wherein the CDMA Neighbor Indication information is a newly defined Media Access Control (MAC) management message.

40. The receiver of claim 39, wherein the CDMA Neighbor Indication information comprises at least one of a CDMA protocol revision, a band class, a channel number, a system identification number (SID), a network identification number (NID), a packet zone identifier (ID), and a pilot pseudo noise (PN) offset.

41. The receiver of claim 34, wherein the first RAT is CDMA (Code Division Multiple Access), the second RAT is WiMAX (Worldwide Interoperability for Microwave Access), and the received information is WiMAX Neighbor Indication information.

42. The receiver of claim 41, wherein the first RAT is CDMA Evolution-Data Optimized (EVDO).

43. The receiver of claim 41, wherein the communication logic is configured to receive a new sector broadcast message that includes the WiMAX Neighbor Indication information.

44. The receiver of claim 41, wherein the WiMAX Neighbor Indication information comprises at least one of a frequency assignment (FA) index, a bandwidth, a fast Fourier transform (FFT) size, an orthogonal frequency-division multiplexing (OFDM) or orthogonal frequency division multiple access (OFDMA) frame duration, a ratio of cyclic prefix (CP), an operator identifier (ID), and a preamble index.

45. A mobile device, comprising:
a receiver front end for communicating via a first radio access technology (RAT);
communication logic configured to receive neighbor indication information about network service via a second RAT while communicating via the first RAT, wherein the first and second RATs are different;
scanning logic configured to scan for the second RAT using the received information; and
handover-determination logic configured to determine whether to handover to network service via the second RAT based on results of the scan.

46. The mobile device of claim 45, wherein the first RAT is WiMAX (Worldwide Interoperability for Microwave Access), the second RAT is CDMA (Code Division Multiple Access), and the received information is CDMA Neighbor Indication information.

47. The mobile device of claim 46, wherein the second RAT is CDMA Evolution-Data Optimized (EVDO) or CDMA 1x.

48. The mobile device of claim 46, wherein the CDMA Neighbor Indication information is a new information element (IE) in an existing Media Access Control (MAC) management message.

49. The mobile device of claim 48, wherein the existing MAC management message is at least one of a Downlink Channel Descriptor (DCD) message or an Uplink Channel Descriptor (UCD) message.

50. The mobile device of claim 46, wherein the CDMA Neighbor Indication information is a newly defined Media Access Control (MAC) management message.

51. The mobile device of claim 50, wherein the CDMA Neighbor Indication information comprises at least one of a CDMA protocol revision, a band class, a channel number, a system identification number (SID), a network identification number (NID), a packet zone identifier (ID), and a pilot pseudo noise (PN) offset.

52. The mobile device of claim 45, wherein the first RAT is CDMA (Code Division Multiple Access), the second RAT is WiMAX (Worldwide Interoperability for Microwave Access), and the received information is WiMAX Neighbor Indication information.

53. The mobile device of claim 52, wherein the first RAT is CDMA Evolution-Data Optimized (EVDO).

54. The mobile device of claim 52, wherein the communication logic is configured to receive a new sector broadcast message that includes the WiMAX Neighbor Indication information.

55. The mobile device of claim 52, wherein the WiMAX Neighbor Indication information comprises at least one of a frequency assignment (FA) index, a bandwidth, a fast Fourier transform (FFT) size, an orthogonal frequency-division multiplexing (OFDM) or orthogonal frequency division multiple access (OFDMA) frame duration, a ratio of cyclic prefix (CP), an operator identifier (ID), and a preamble index.

56. A method for assisting handover between network service via first and second radio access technologies (RATs), comprising:
communicating via the first RAT; and
transmitting information about network service via the second RAT, wherein the first and second RATs are different.

57. The method of claim 56, wherein the first RAT is WiMAX (Worldwide Interoperability for Microwave Access), the second RAT is CDMA (Code Division Multiple Access), and the transmitted information is CDMA Neighbor Indication information.

58. The method of claim 57, wherein the second RAT is CDMA Evolution-Data Optimized (EVDO) or CDMA 1x.

59. The method of claim 57, wherein the CDMA Neighbor Indication information is transmitted as a new information element (IE) in an existing Media Access Control (MAC) management message.

60. The method of claim 59, wherein the existing MAC management message is at least one of a Downlink Channel Descriptor (DCD) message or an Uplink Channel Descriptor (UCD) message.

61. The method of claim 57, wherein the CDMA Neighbor Indication information is transmitted as a newly defined Media Access Control (MAC) management message.

62. The method of claim 61, wherein the CDMA Neighbor Indication information comprises at least one of a CDMA protocol revision, a band class, a channel number, a system identification number (SID), a network identification number (NID), a packet zone identifier (ID), and a pilot pseudo noise (PN) offset.

63. The method of claim 56, wherein the first RAT is CDMA (Code Division Multiple Access), the second RAT is WiMAX (Worldwide Interoperability for Microwave Access), and the transmitted information is WiMAX Neighbor Indication information.

64. The method of claim 63, wherein the first RAT is CDMA Evolution-Data Optimized (EVDO).

65. The method of claim 63, wherein the WiMAX Neighbor Indication information is transmitted as a new sector broadcast message.

66. The method of claim 63, wherein the WiMAX Neighbor Indication information comprises at least one of a frequency assignment (FA) index, a bandwidth, a fast Fourier transform (FFT) size, an orthogonal frequency-division multiplexing (OFDM) or orthogonal frequency division multiple access (OFDMA) frame duration, a ratio of cyclic prefix (CP), an operator identifier (ID), and a preamble index.

67. A computer-program apparatus for assisting handover between network service via first and second radio access technologies (RATs) comprising a computer readable medium having instructions stored thereon, the instructions being executable by one or more processors and the instructions comprising:
instructions for communicating via the first RAT; and
instructions for transmitting information about network service via the second RAT, wherein the first and second RATs are different.

68. The computer-program apparatus of claim 67, wherein the first RAT is WiMAX (Worldwide Interoperability for Microwave Access), the second RAT is CDMA (Code Division Multiple Access), and the transmitted information is CDMA Neighbor Indication information.

69. The computer-program apparatus of claim 68, wherein the second RAT is CDMA Evolution-Data Optimized (EVDO) or CDMA 1x.

70. The computer-program apparatus of claim 68, wherein the CDMA Neighbor Indication information is transmitted as a new information element (IE) in an existing Media Access Control (MAC) management message.

71. The computer-program apparatus of claim 70, wherein the existing MAC management message is at least one of a Downlink Channel Descriptor (DCD) message or an Uplink Channel Descriptor (UCD) message.

72. The computer-program apparatus of claim 68, wherein the CDMA Neighbor Indication information is transmitted as a newly defined Media Access Control (MAC) management message.

73. The computer-program apparatus of claim 72, wherein the CDMA Neighbor Indication information comprises at least one of a CDMA protocol revision, a band class, a channel number, a system identification number (SID), a network identification number (NID), a packet zone identifier (ID), and a pilot pseudo noise (PN) offset.

74. The computer-program apparatus of claim 67, wherein the first RAT is CDMA (Code Division Multiple Access), the second RAT is WiMAX (Worldwide Interoperability for Microwave Access), and the transmitted information is WiMAX Neighbor Indication information.

75. The computer-program apparatus of claim 74, wherein the first RAT is CDMA Evolution-Data Optimized (EVDO).

76. The computer-program apparatus of claim 74, wherein the WiMAX Neighbor Indication information is transmitted as a new sector broadcast message.

77. The computer-program apparatus of claim 74, wherein the WiMAX Neighbor Indication information comprises at least one of a frequency assignment (FA) index, a bandwidth, a fast Fourier transform (FFT) size, an orthogonal frequency-division multiplexing (OFDM) or orthogonal frequency division multiple access (OFDMA) frame duration, a ratio of cyclic prefix (CP), an operator identifier (ID), and a preamble index.

78. An apparatus for assisting handover between network service via first and second radio access technologies (RATs), comprising:
means for communicating via the first RAT; and
means for transmitting information about network service via the second RAT, wherein the first and second RATs are different.

79. The apparatus of claim 78, wherein the first RAT is WiMAX (Worldwide Interoperability for Microwave Access), the second RAT is CDMA (Code Division Multiple Access), and the transmitted information is CDMA Neighbor Indication information.

80. The apparatus of claim 79, wherein the second RAT is CDMA Evolution-Data Optimized (EVDO) or CDMA 1x.

81. The apparatus of claim 79, wherein the CDMA Neighbor Indication information is transmitted as a new information element (IE) in an existing Media Access Control (MAC) management message.

82. The apparatus of claim 81, wherein the existing MAC management message is at least one of a Downlink Channel Descriptor (DCD) message or an Uplink Channel Descriptor (UCD) message.

83. The apparatus of claim 79, wherein the CDMA Neighbor Indication information is transmitted as a newly defined Media Access Control (MAC) management message.

84. The apparatus of claim 83, wherein the CDMA Neighbor Indication information comprises at least one of a CDMA protocol revision, a band class, a channel number, a system identification number (SID), a network identification number (NID), a packet zone identifier (ID), and a pilot pseudo noise (PN) offset.

85. The apparatus of claim 78, wherein the first RAT is CDMA (Code Division Multiple Access), the second RAT is WiMAX (Worldwide Interoperability for Microwave Access), and the transmitted information is WiMAX Neighbor Indication information.

86. The apparatus of claim 85, wherein the first RAT is CDMA Evolution-Data Optimized (EVDO).

87. The apparatus of claim 85, wherein the means for transmitting transmits the WiMAX Neighbor Indication information as a new sector broadcast message.

88. The apparatus of claim 85, wherein the WiMAX Neighbor Indication information comprises at least one of a frequency assignment (FA) index, a bandwidth, a fast Fourier transform (FFT) size, an orthogonal frequency-division multiplexing (OFDM) or orthogonal frequency division multiple access (OFDMA) frame duration, a ratio of cyclic prefix (CP), an operator identifier (ID), and a preamble index.

89. A transmitter for wireless communication, comprising:
communication logic configured to communicate via a first radio access technology (RAT); and
transmission logic configured to transmit information about network service via a second RAT, wherein the first and second RATs are different.

90. The transmitter of claim 89, wherein the first RAT is WiMAX (Worldwide Interoperability for Microwave Access), the second RAT is CDMA (Code Division Multiple Access), and the transmitted information is CDMA Neighbor Indication information.

91. The transmitter of claim 90, wherein the second RAT is CDMA Evolution-Data Optimized (EVDO) or CDMA 1x.

92. The transmitter of claim 90, wherein the CDMA Neighbor Indication information is transmitted as a new information element (IE) in an existing Media Access Control (MAC) management message.

93. The transmitter of claim 92, wherein the existing MAC management message is at least one of a Downlink Channel Descriptor (DCD) message or an Uplink Channel Descriptor (UCD) message.

94. The transmitter of claim 90, wherein the CDMA Neighbor Indication information is transmitted as a newly defined Media Access Control (MAC) management message.

95. The transmitter of claim 94, wherein the CDMA Neighbor Indication information comprises at least one of a CDMA protocol revision, a band class, a channel number, a system identification number (SID), a network identification number (NID), a packet zone identifier (ID), and a pilot pseudo noise (PN) offset.

96. The transmitter of claim 89, wherein the first RAT is CDMA (Code Division Multiple Access), the second RAT is WiMAX (Worldwide Interoperability for Microwave Access), and the transmitted information is WiMAX Neighbor Indication information.

97. The transmitter of claim 96, wherein the first RAT is CDMA Evolution-Data Optimized (EVDO).

98. The transmitter of claim 96, wherein the transmission logic transmits the WiMAX Neighbor Indication information as a new sector broadcast message.

99. The transmitter of claim 96, wherein the WiMAX Neighbor Indication information comprises at least one of a frequency assignment (FA) index, a bandwidth, a fast Fourier transform (FFT) size, an orthogonal frequency-division multiplexing (OFDM) or orthogonal frequency division multiple access (OFDMA) frame duration, a ratio of cyclic prefix (CP), an operator identifier (ID), and a preamble index.

100. A base station, comprising:
communication logic configured to communicate via a first radio access technology (RAT); and
a transmitter front end for transmitting information about network service via a second RAT, wherein the first and second RATs are different.

101. The base station of claim 100, wherein the first RAT is WiMAX (Worldwide Interoperability for Microwave Access), the second RAT is CDMA (Code Division Multiple Access), and the transmitted information is CDMA Neighbor Indication information.

102. The base station of claim 101, wherein the second RAT is CDMA Evolution-Data Optimized (EVDO) or CDMA 1x.

103. The base station of claim 101, wherein the CDMA Neighbor Indication information is transmitted as a new information element (IE) in an existing Media Access Control (MAC) management message.

104. The base station of claim 103, wherein the existing MAC management message is at least one of a Downlink Channel Descriptor (DCD) message or an Uplink Channel Descriptor (UCD) message.

105. The base station of claim 101, wherein the CDMA Neighbor Indication information is transmitted as a newly defined Media Access Control (MAC) management message.

106. The base station of claim 105, wherein the CDMA Neighbor Indication information comprises at least one of a CDMA protocol revision, a band class, a channel number, a system identification number (SID), a network identification number (NID), a packet zone identifier (ID), and a pilot pseudo noise (PN) offset.

107. The base station of claim 100, wherein the first RAT is CDMA (Code Division Multiple Access), the second RAT is WiMAX (Worldwide Interoperability for Microwave Access), and the transmitted information is WiMAX Neighbor Indication information.

108. The base station of claim 107, wherein the first RAT is CDMA Evolution-Data Optimized (EVDO).

109. The base station of claim 107, wherein the transmitter front end transmits the WiMAX Neighbor Indication information as a new sector broadcast message.

110. The base station of claim 107, wherein the WiMAX Neighbor Indication information comprises at least one of a frequency assignment (FA) index, a bandwidth, a fast Fourier transform (FFT) size, an orthogonal frequency-division multiplexing (OFDM) or orthogonal frequency division multiple access (OFDMA) frame duration, a ratio of cyclic prefix (CP), an operator identifier (ID), and a preamble index.
